(19) United States
(12) Patent Application Publication
(10) Pub. No.: US 2005/0159146 A1
(43) Pub. Date: Jul. 21, 2005

(54) Method for registering absent subscriber messages and setting absent subscriber mode

(75) Inventor: Yong Jik Lee, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 11/038,949

(22) Filed: Jan. 19, 2005

(30) Foreign Application Priority Data
Jan. 20, 2004 (KR) 4350/2004

(51) Int. Cl. H04M 3/00

(52) U.S. Cl. 455/418

(57) ABSTRACT

A method for registering absent subscriber messages and setting an absent subscriber mode in a portable terminal is provided. The method sets a state of the terminal to an absent subscriber mode, transmits a message of the set absent subscriber mode to a terminal of a calling party if a call is received at a called party, and processes the received call depending on the absent subscriber mode. Through above processes, the method informs an exact reason regarding absent subscriber situation to the terminal of the calling party, thereby preventing repeated calling and wastes of wireless resources.

### BACKGROUND OF THE INVENTION

1. Field of the Invention

The present invention relates to a cellular phone, and more particularly, to a method for registering absent subscriber messages and setting an absent subscriber mode in a terminal that allows the absent subscriber message set under the absent subscriber mode to be transmitted to a subscriber of a calling party.

2. Description of the Related Art

Thanks to remarkable developments in an information and telecommunication field, information and telecommunication environments are rapidly changing. Particularly, a subscriber using a mobile communication terminal which is convenient to carry is increasing as time goes on and a demand for a cellular phone is also increasing. Therefore, new functions for providing a convenience to a cellular phone are added and researches thereof are being constantly made. The cellular phones provide a variety of additional services such as message transmission and reception, a data storing function, a web service, a multimedia playing function as well as a telephone function.

Further, the cellular phone provides a caller identification (ID) display service, a call reception during absence of a subscriber, a voice mail service, a manner mode as convenient functions for a subscriber.

Here, there exist several reasons why a subscriber of a cellular phone cannot answer a call from other subscriber. For example, power of a portable terminal may be turned off, the portable terminal may get out of a service area, or a subscriber cannot answer a call or does not answer a call.

In those cases, the following absent subscriber messages are delivered to a cellular phone of the called party:

First,—“Power of a subscriber cellular phone is turned off and the phone cannot answer a call.”;

Second,—“Subscriber has got out of a call coverage and the phone cannot answer a call.”;

Third,—“Since a subscriber cannot answer a call, a voice mail is connected.”;

Fourth,—“Now, a subscriber cannot answer a call. Please, call again.”

Here, the first and the second messages provide detail information that the subscriber's cellular phone is in a state in which a call cannot be properly answered. In that case, since a calling party can know a detail reason why the called party cannot answer a call, the calling party does not try redialing.

However, since a detail reason why the called party cannot answer a call is not revealed in the third and the fourth messages, the calling party persists to try redialing.

In other words, in cases of the third and the fourth messages, there is a possibility that the called party cannot answer a call because the called party was not able to perceive a bell/vibration of the cellular phone. Thus, the calling party repeatedly tries redialing and finally communication may be connected. In the meantime, a button can be falsely selected while the called party takes out the cellular phone to answer a call and so an absent subscriber message might be transmitted to the calling party. In those cases, the calling party repeatedly tries a call connection to the called party.

On the contrary, in case that the called party is really in a situation in which the called party cannot answer a call, the called party turns off power of the cellular phone in order to avoid inconvenience that a call repeatedly comes in. In that case, the called party is in a situation such that the called party cannot even explain the calling party a detail reason why a call cannot be answered and so hangs up the phone.

As described above, when a call coming from the calling party cannot be answered by the cellular phone in a related art, an inconvenience is generated to the called party or the calling party due to an unclear reason for the called party's absence.

### SUMMARY OF THE INVENTION

Accordingly, the present invention is directed to a method for registering absent subscriber messages and setting an absent subscriber mode that substantially obviates one or more problems due to limitations and disadvantages of the related art.

An object of the present invention is to provide a method for registering in advance detail absent subscriber circumstances, reasons of an absent subscriber through absent subscriber messages.

Another object of the present invention is to provide a method for registering, by a subscriber, absent subscriber messages for the respective absent subscriber circumstances, and setting an absent subscriber mode desired by the subscriber among the registered absent subscriber messages to transmit the absent subscriber mode to a terminal of a calling party.

Yet another object of the present invention is to provide a method for setting an absent subscriber mode using a hot key registered as absent subscriber message information.

Further another object of the present invention is to provide a method for setting an absent subscriber mode, wherein if a call is received under the absent subscriber mode an absent subscriber message is automatically delivered to a calling party.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for registering absent subscriber messages in a terminal, which includes the steps of: displaying an absent subscriber message registration screen using a function key of the terminal; inputting absent subscriber message information displayed on the screen; and if the inputting of the absent subscriber message information is completed, registering the inputted information as the absent subscriber message.

Here, the absent subscriber message information includes an absent subscriber message title, an absent subscriber message content, an absent subscriber message hot-key, and an option.

In another aspect of the present invention, there is provided a method for setting an absent subscriber mode in a terminal, which includes the steps of: registering, by a subscriber, absent subscriber messages for respective absent subscriber circumstances; setting an absent subscriber message selected by the subscriber of the terminal among the registered absent subscriber messages as an absent subscriber mode; if a call is received at the terminal, transmitting the absent subscriber message of the absent subscriber mode to a terminal of a calling party.

In further another aspect of the present invention, there is provided a method for setting an absent subscriber mode in a terminal, which includes the steps of: setting a state of a terminal to an absent subscriber mode; and if a call is received at the terminal, transmitting, at the terminal, part of the message information of the set absent subscriber mode to a terminal of a calling party and processing the received call depending on the absent subscriber mode.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view of a mobile communication system configuration according to the present invention;

FIG. 2 is a flowchart of a method for registering and setting absent subscriber messages of a terminal according to the present invention;

FIG. 3 is a flowchart of a method for registering and setting absent subscriber messages of a terminal according to the present invention; and

FIG. 4 is a view illustrating absent subscriber message registration items of a terminal according to the present invention;

FIG. 5 is a view illustrating a state in which an absent subscriber message content and an absent subscriber message of the present invention are set;

FIG. 6 is a view illustrating an absent subscriber message list and a screen setting state of a terminal according to the present invention;

FIG. 7 is a flowchart of a first embodiment of a method for registering absent subscriber messages according to the present invention;

FIG. 8 is a flowchart of a second embodiment of a method for registering absent subscriber messages according to the present invention;

FIG. 9 is a flowchart of a third embodiment of a method for registering absent subscriber messages according to the present invention;

FIG. 10 is a flowchart of a first embodiment of a method for setting an absent subscriber mode;

FIG. 11 is a flowchart of a second embodiment of a method for setting an absent subscriber mode;

FIG. 12 is a flowchart of a third embodiment of a method for setting an absent subscriber mode; and

FIG. 13 is a flowchart of a method for operating an absent subscriber mode of a terminal according to an embodiment of the present invention.

### DETAILED DESCRIPTION OF THE INVENTION

Reference will now be made in detail to the preferred embodiments of the present invention, examples of which are illustrated in the accompanying drawings.

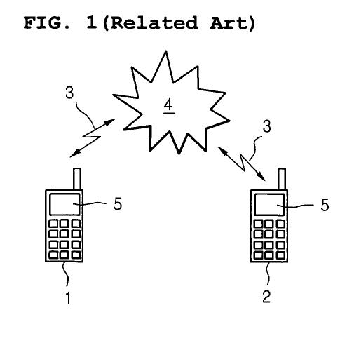

FIG. 1 is a view of a mobile communication system configuration according to the present invention.

Referring to FIG. 1, terminals 1 and 2 communicate with a mobile communication system 4 through wireless channel. A subscriber can set an absent subscriber mode and an absent subscriber message using his terminal 1. If the terminal 1 of a called party is set to an absent subscriber mode, an absent subscriber message is displayed on a display 5.

Under such a configuration, if a call is originated from a terminal 2 of a calling party and delivered to a terminal 2 of a called party, the terminal 2 of the called party operates according to an option set at a predetermined absent subscriber mode set in advance and simultaneously informs an absent subscriber message to the terminal of the calling party 2 through a mobile communication system 4.

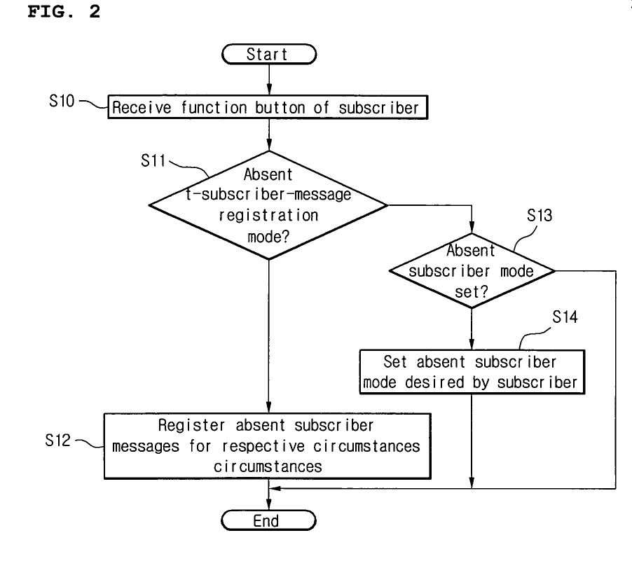

FIG. 2 is a flowchart of a method for registering and setting absent subscriber messages of an absent subscriber mode according to the present invention.

Referring to FIG. 2, a function button is received from a subscriber (S10). At this point, whether the received function button is an absent-subscriber-message registration mode button or an absent-subscriber setting mode button is checked (S11 and S13). If the received function button is the absent-subscriber-message registration mode button as a result of the checking at the step S11, an absent-subscriber-message registration mode is performed and absent subscriber messages for respective circumstances are selected or inputted, respectively, to register the absent subscriber messages (S12).

If the received function button is an absent-subscriber setting mode button as a result of the checking at the step S13, absent subscriber modes for respective circumstances stored in advance are provided and a currently desired predetermined absent subscriber mode is set (S14).

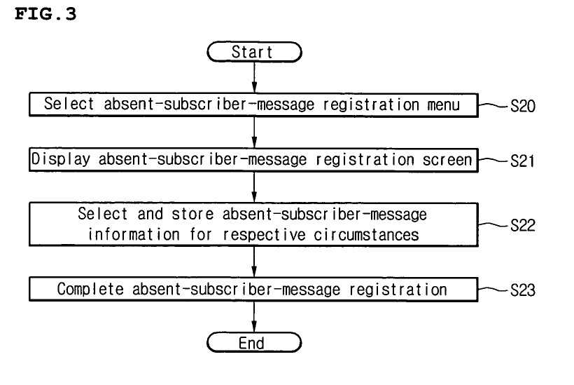

FIG. 3 is a flowchart of a method for registering an absent subscriber mode according to an embodiment of the present invention.

Referring to FIG. 3, if an absent subscriber message registration menu is selected by a subscriber (S20), an absent subscriber message registration screen is displayed (S21). The subscriber selects or inputs and then stores absent subscriber message information for respective circumstances (S22), thereby completing registration of one absent subscriber message (S23).

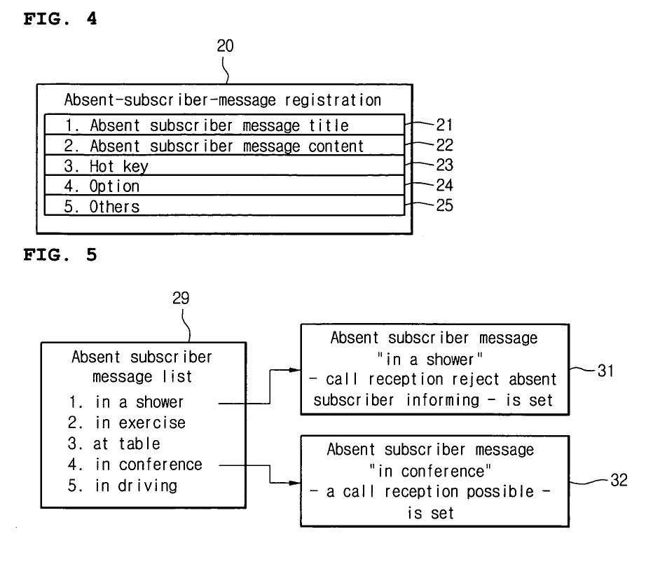

That is, if the absent subscriber message registration menu is selected through a user interface, the absent subscriber message registration screen 20 is displayed as illustrated in FIG. 4. At this point, the subscriber can set and register the absent subscriber message by selecting or inputting an absent subscriber title 21, an absent subscriber content 22, a hot key item 23, an option item 24, and others 35.

Here, the absent subscriber message title 21 can be stored by identifiers such as absent subscriber messages 1, 2, and 3, or can be inputted by names that can be recognized by a subscriber, for example, by phrases representing a current state of a subscriber such as “in a shower”, “in exercise”, “at table”, “in conference”, “in driving”. Further, the absent subscriber message title 21 can be selected and inputted by absent subscriber identifying information such as icons depending on kinds of portable terminals.

In addition, for the absent subscriber message content 22, a content downloaded by a subscriber or a voice message of a subscriber can be used or other audio signals can be recorded or downloaded for use.

The hot key item 23 is a hot key number generated when a current absent subscriber message is registered. The hot key number includes a combination of one or more numerals and/or letters, or can be designated by other function keys.

Using the option item 24, a subscriber can select a detail processing direction with respect to a received call upon reception of a call under the absent subscriber mode. For example, the subscriber can set a call reception reject, a call reception possible, or a function of leaving an absent subscriber call record after transmission of the absent subscriber message before a call informing function.

FIG. 5 is a view of a state in which an absent subscriber message content and an absent subscriber message are set according to the present invention.

If a subscriber sees an absent subscriber message list screen 29 and selects one absent subscriber message on the displayed absent subscriber message list screen, a corresponding absent subscriber mode is set. For example, if an absent subscriber mode of “in a shower” is set, “absent subscriber message” is displayed as a title and “in a shower—call reception reject absent subscriber informing—is set” is displayed (31). For another example, an absent subscriber message of “in conference” is displayed as “in conference—a call reception possible—is set” (32). If an arbitrary absent subscriber message is set with a call reception reject, the absent subscriber message is immediately transmitted to a calling party without a call informing function such as a bell/vibration and only caller information is recorded.

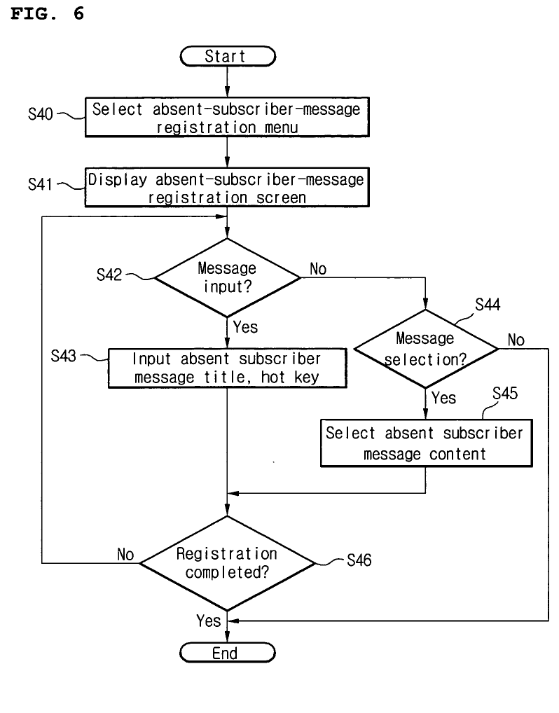

FIG. 6 is a flowchart of a method for registering absent subscriber messages according to a first embodiment of the present invention.

Referring to FIG. 6, if an absent subscriber message registration menu is selected (S40), an absent subscriber message registration screen is displayed (S41). At this point, whether an absent subscriber message input is made by a subscriber (S42), or an absent subscriber message selection is made by a subscriber is checked (S43).

If the absent subscriber message input is made by the subscriber, an absent subscriber message title and a hot key are inputted (S43). If the absent subscriber message selection is made by the subscriber, a predetermined absent subscriber message content stored in advance is selected (S45). If the input of the absent subscriber message title and content are completed in this manner, the registration of the absent subscriber message is completed (S46).

Here, the subscriber can input a voice signal generated from an external electronic apparatus or his voice signal in person. Referring to FIG. 5, if the absent subscriber message title such as “in a shower”, “in conference” is displayed on a list in connection with the absent subscriber message selection item, a subscriber may select the absent subscriber message title.

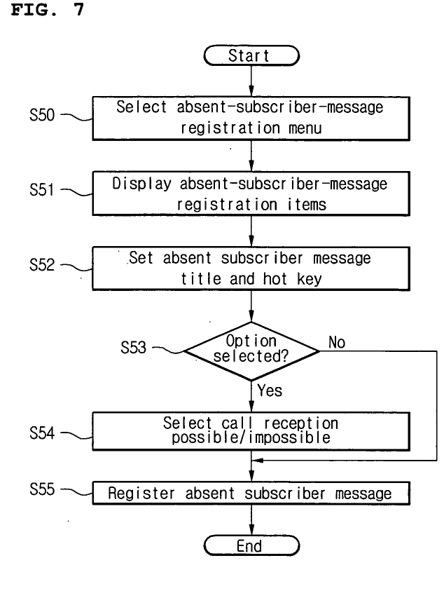

FIG. 7 is a flowchart of a method for registering absent subscriber messages according to a third embodiment of the present invention.

Referring to FIG. 7, if the absent subscriber message registration menu is selected, absent subscriber message registration items are displayed (S50 and S51). At this point, if the absent subscriber title and a hot key thereof are set by a subscriber (S52), whether the subscriber selects an option is checked (S53). Here, the step S52 can be performed after the step S53.

If the option is selected, option items are provided. For example, the option items such as a call reception possible, transmission of an absent subscriber message upon call reception, or a call reception impossible are provided (S54). If a specific option item is selected among these option items by a subscriber, the selected option item is set to the absent subscriber message (S55). Accordingly, the absent subscriber message to which the option function is added can be registered.

Further, whether to transmit the absent subscriber message before a call informing function such as bell/vibration, displaying lamp can be set for the option items.

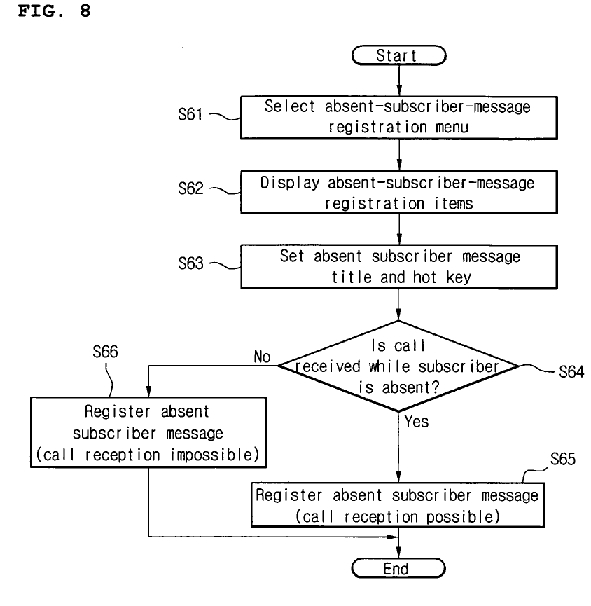

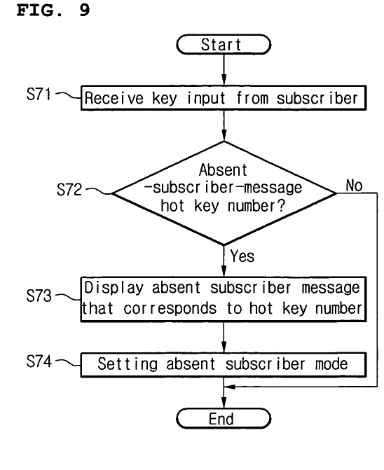

FIG. 8 is a flowchart of a method for registering absent subscriber messages according to a third embodiment of the present invention.

Referring to FIG. 8, the absent subscriber message menu is selected (S61) and the absent subscriber message registration items are displayed (S62). At this point, after the absent subscriber message title and a hot key thereof are set (S63), the option is selected (S64). Here, the steps S63 and S64 can be arbitrarily changed in their order by selection of a subscriber.

The subscriber checks whether an absent subscriber call reception option is marked on an option list (S64). If the subscriber selects a call reception, the absent subscriber message is registered as being call reception possible (S65). If the subscriber selects a call reception impossible, the absent subscriber message is registered as being call reception impossible (S66).

FIG. 9 is a view of a method for setting an absent subscriber mode according to a first embodiment of the present invention.

Referring to FIG. 9, if a key input by a subscriber is received (S71), whether the key input is an absent-subscriber-message hot key number is checked (S72). If the key input is the absent-subscriber-message hot key number as a result of the checking, an absent subscriber message that corresponds to the hot key number is displayed (S73) and the terminal is set to the absent subscriber mode (S74).

In other words, if a hot key, e.g., “1*” is consecutively pressed so as to set an absent subscriber message registered in advance, the absent subscriber mode that corresponds to this hot key number is set.

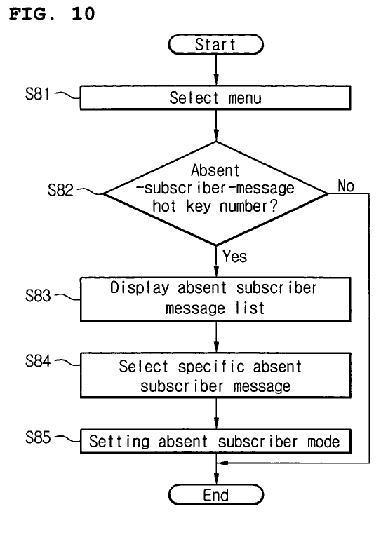

FIG. 10 is a flowchart of a method for setting an absent subscriber mode according to a second embodiment of the present invention.

Referring to FIG. 10, if a menu is selected on a terminal by a subscriber (S81), whether the menu is the absent-subscriber-message setting menu is checked (S82). If the menu is the absent-subscriber-message setting menu, the absent subscriber message items set in advance are displayed to the subscriber (S83). After that, if a desired predetermined absent subscriber message item is selected by the subscriber (S84), the corresponding absent subscriber message is set as the absent subscriber mode (S85). That is, a list of the absent subscriber messages registered in advance is displayed through the absent subscriber setting menu, so that the absent subscriber message suitable for a current circumstance or the absent subscriber message is selected through a key manipulation of the subscriber.

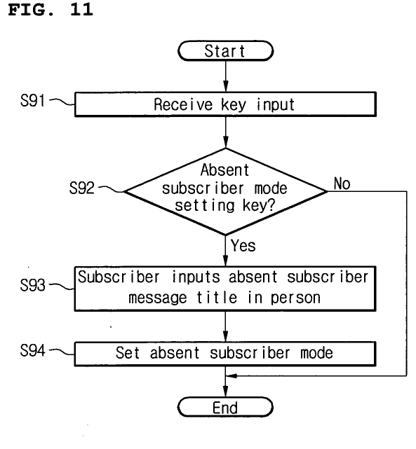

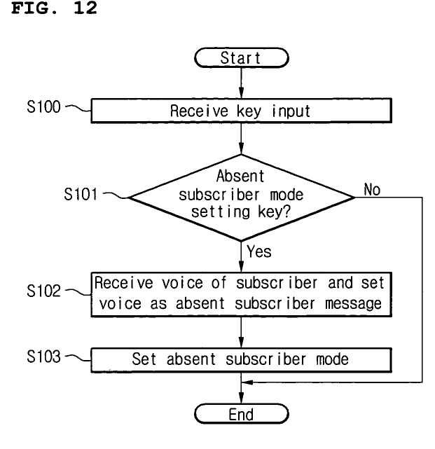

FIG. 11 is a flowchart of a method for setting an absent subscriber mode according to a third embodiment of the present invention.

Referring to FIG. 11, whether an inputted key signal is an absent subscriber mode setting key is checked (S91 and S92) If the key signal is the absent subscriber mode setting key as a result of the checking at the step S92, absent subscriber mode setting items are displayed so that a subscriber may be allowed to input an absent subscriber message title in person (S93). The absent subscriber message inputted by the subscriber is set as the absent subscriber mode (S94).

In other words, the subscriber presses the absent subscriber mode setting key to input the desired absent subscriber message title as a current absent subscriber message title in person, whereby the absent subscriber message inputted by the subscriber is set as the absent subscriber mode. In case the subscriber inputs the absent subscriber message in person, the absent subscriber message stored in advance and that identical with the absent subscriber message can be also set as the absent subscriber mode.

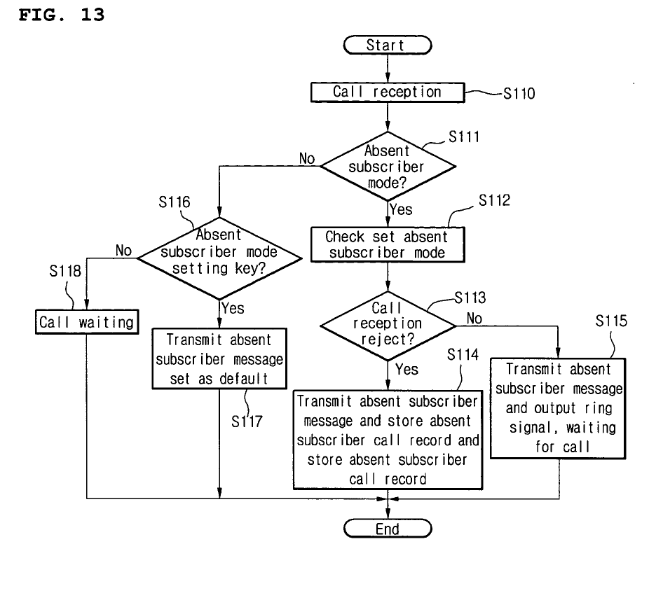

FIG. 12 is a flowchart of a method for setting an absent subscriber mode according to a fourth embodiment of the present invention.

Referring to FIG. 12, whether a key signal inputted from a subscriber is the absent-subscriber-mode setting key is checked (S100 and S101). If the key signal is the absent-subscriber-mode setting key as a result of the checking at the step S101, a voice of the subscriber is directly received and set as an absent subscriber message content set as a default, so that the setting of the absent subscriber mode is completed (S102 and S103).

That is, when the subscriber is busy for other businesses, the subscriber can record his own voice in person with pressing the absent-subscriber-mode setting key, so that the setting of the absent subscriber mode is completed.

FIG. 13 is a flowchart of a method for controlling an absent subscriber mode in a terminal according to the present invention.

Referring to FIG. 13, if a call is received from a terminal of a calling party (S110), a terminal of a called party checks whether a state of the terminal is in an absent subscriber mode (S111).

If the state of the terminal is in the absent subscriber mode as a result of the checking at the step S111, an absent subscriber mode option is checked (S112). At this point, if the option of the absent subscriber message is a call reception reject, the absent subscriber message is transmitted and an absent subscriber call record is recorded so that a subscriber can check the record afterward (S113 and S114).

If the option of the absent subscriber message is not the call reception reject, the absent subscriber message is transmitted to the calling party and a ring signal is outputted and the terminal operates in a call waiting state until the subscriber answer the call (S113 and S115). Here, since the absent subscriber message transmitted to the terminal of the calling party includes the absent subscriber message title and the absent subscriber message content, the absent subscriber message title is displayed on a screen of the terminal of the calling party, and the absent subscriber message content is outputted to the calling party through a speaker.

Further, if the state of the terminal is not the absent subscriber mode upon call reception, whether an absent-subscriber-mode setting key which is a function key is inputted from the subscriber is checked (S116). At this point, if the absent-subscriber-mode setting key is selected by the subscriber, the absent subscriber message set as a default is transmitted to the terminal of the calling party (S117). If the absent-subscriber-mode setting key (or hot key) is not selected, the terminal operates in a call waiting state (S118). That is, the absent subscriber message set as a default is transmitted to the calling party by the absent-subscriber-mode setting key inputted upon call reception, so that information about a call-reception-impossible circumstance or a subscriber being absent is transmitted to the calling party.

Here, for the absent subscriber messages transmitted to the terminal of the calling party, either the absent subscriber message title or the absent subscriber message content, or both the title and the content may be transmitted. Further, if the absent subscriber message content is not set, only the absent subscriber message title can be transmitted.

Further, the subscriber of the terminal having the above-described absent subscriber mode function can set the absent subscriber mode for sleeping using time reservation of the absent subscriber mode for sleeping or using the hot key. In addition, the subscriber can set the absent subscriber mode using the hot key when driving.

As described above, the method for registering the absent subscriber messages and setting the absent subscriber mode in the terminal can exactly inform the absent subscriber reasons or circumstances such as “in conference”, “under operation”, “in driving” to the terminal of the calling party and preventing wastes of wireless resources due to repeated calling from the calling party by registering the absent subscriber messages on the terminal and setting the absent subscriber mode.

Further, the method can provide convenient services to the calling party by providing a variety of circumstances or situations of the called party through the absent subscriber mode.

It will be apparent to those skilled in the art that various modifications and variations can be made in the present invention. Thus, it is intended that the present invention covers the modifications and variations of this invention provided they come within the scope of the appended claims and their equivalents.

1. A method for registering an absent subscriber message in a terminal, comprising the steps of:
displaying an absent subscriber message registration screen using a function key of the terminal;
inputting absent subscriber message information displayed on the screen; and
if the inputting of the absent subscriber message information is completed, registering the inputted information as an absent subscriber message.

2. The method of claim 1, wherein the absent subscriber message information comprises at least two or more items among an absent subscriber message title, an absent subscriber message content, and an absent subscriber message hot-key.

3. The method of claim 2, wherein the absent subscriber message title is an item for representing a situation which a subscriber faces, in which a list for respective circumstances is provided on the terminal or the absent subscriber message title is directly inputted by the subscriber.

4. The method of claim 2, wherein the absent subscriber message content is a message to be informed of to a terminal of a called party and comprises a voice signal recorded by a subscriber or a downloaded content.

5. The method of claim 1, wherein the absent subscriber message information further comprises call reception option items for processing a received call when the call is received under an absent subscriber mode.

6. The method of claim 5, wherein the option items comprise a call reception reject function upon reception of a call and a call reception function, and one of the functions is registered as the call reception option of the absent subscriber message.

7. A method for setting an absent subscriber mode in a terminal, comprising the steps of:
registering, by a subscriber, absent subscriber messages for respective absent subscriber circumstances;
setting an absent subscriber message selected by the subscriber of the terminal among the registered absent subscriber messages as an absent subscriber mode; and
if a call is received at the terminal, transmitting the absent subscriber message of the absent subscriber mode to a terminal of a calling party.

8. The method of claim 7, further comprising the step of: if the absent subscriber mode is set, displaying absent subscriber message information on a screen of the terminal.

9. The method of claim 7, wherein the absent subscriber mode is set by selection of a hot key or through an absent subscriber mode setting menu.

10. The method of claim 7, wherein the absent subscriber message transmitted to the terminal of the calling party is an absent subscriber message comprising a voice signal recorded in the absent subscriber message or a downloaded content.

11. The method of claim 7, wherein the absent subscriber message transmitted to the terminal of the calling party is an absent subscriber message title representing subscriber state information, including “in driving” or “in a shower”.

12. The method of claim 7, further comprising the steps of:
if a call is received, checking whether a state of the terminal is the absent subscriber mode;
if the state of the terminal is the absent subscriber mode as a result of the checking, checking a call reception option of the absent subscriber message; and
controlling whether to inform the received call depending on the call reception option and transmitting the absent subscriber message to the terminal of the calling party.

13. The method of claim 7, wherein the call reception option item for the absent subscriber message is one of a call reception reject function and a call reception function.

14. The method of claim 13, wherein the call reception option item for the absent subscriber message selects whether to set a call informing function.

15. The method of claim 13, further comprising the steps of:
if the call reception option of the absent subscriber message is the call reception reject function, automatically transmitting the set absent subscriber message to the terminal of the calling party upon reception of a call;
disabling a call informing function of the terminal of the called party; and
storing an absent subscriber call record.

16. The method of claim 13, further comprising the step of:
if the call reception option item of the absent subscriber message is the call reception function, automatically transmitting the absent subscriber message to the terminal of the calling party upon reception of a call, and calling the called party depending on a call informing mode, including a bell and a vibration set at the terminal of the called party.

17. The method of claim 11, further comprising the step of:
if a call is received under the absent subscriber mode, automatically storing an absent subscriber call record.

18. A method for setting an absent subscriber mode in a terminal, comprising the steps of:
setting a state of a terminal to an absent subscriber mode; and
if a call is received at the terminal, transmitting, at the terminal, part of absent subscriber message information of the set absent subscriber mode to a terminal of a calling party and processing the received call depending on the absent subscriber mode.

19. The method of claim 18, wherein the absent subscriber message information comprises: an absent subscriber message title representing an absent subscriber state, including “in conference”, “in a shower”, “in driving”, an absent subscriber message content for informing the absent subscriber state, a hot-key for shortening and setting the absent subscriber message, and an option for processing whether to receive an absent subscriber call.

20. The method of claim 18, further comprising the steps of:
automatically transmitting an absent subscriber message content registered at an absent subscriber message to the terminal of the calling party;
disabling a call informing function; and
leaving an absent subscriber call record.
